(19) United States
(12) Patent Application Publication
(10) Pub. No.: US 2008/0243840 A1
(43) Pub. Date: Oct. 2, 2008

(54) COMPARING DATA SETS THROUGH IDENTIFICATION OF MATCHING BLOCKS

(75) Inventor: Vaibhav Bhandari, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/693,407

(22) Filed: Mar. 29, 2007

(51) Int. Cl. G06F 17/30

(52) U.S. Cl. 707/6; 707/E17.001

(57) ABSTRACT

A computer readable storage medium stores instructions to receive a source data set and a target data set. Instructions to identify differences between the target data set and the source data set are also stored. These instructions include dividing the target data set into a set of target data blocks. Among the target data blocks at least one duplicate block in which an unbroken copy is fully duplicated within the source data set is identified. At least one modified block among the target data blocks in which an unbroken copy is not fully duplicated within the source data set is also identified. Differences between the modified block and the source data set are then determined.

### BACKGROUND

Comparing complex sets of data, such as lengthy documents, genetic sequences, or versions of software programs, may be a very computationally-intensive and time-consuming task. The task becomes more difficult when one wishes to quickly and compactly represent the differences between the two data sets.

For example, if the data sets are two versions of a software program, one might wish to generate a difference set that represents the differences between a previous version and a later version. The difference set can then be delivered to a system using the previous version, and the software can be updated to the later version without having to transmit the entire later version to the user. Particularly when the system has limited storage or memory capacities or may receive updates over a wireless network or other network where bandwidth may be at a premium, being able to update the software by transmitting a difference set instead of transmitting the entire later version may be beneficial.

Unfortunately, generating a compact difference set may be a time-intensive process. Conventional methods of generating a difference set may take hours, days, or even a longer period of time depending on the computing resources available to generate the difference set and the size of the data sets.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure is directed to methods and systems for efficiently identifying differences between data sets. Generally, source and target data sets are received. The target data set is divided into blocks. To compare the two data sets, the target data blocks for which an exact copy of their content is located within the source data set are first identified. The differences between the remaining target data blocks and the source data set are then identified by executing a longest subsequence matching process. By first identifying the target blocks that are fully duplicated in the source data set, the execution of a longest subsequence matching process on those blocks is avoided and computation time is thereby reduced. In some implementations a difference set that indicates the identified differences and similarities between the target data set and the source data set is also created.

In an implementation of a computer-implemented method, a source data set and a target data set are received. Differences between the target data set and the source data set are identified by dividing the target data set into a set of target data blocks. Among the target data blocks at least one duplicate block that is identical to a first portion of the source data set is identified. At least one modified block among the target data blocks for which complete, unbroken content of the modified block is not included within the source data set is identified. Differences between the modified block and the source data set are determined.

In an implementation of a computer-implemented method of generating a difference set, a source data set and a target data set are received. Differences between the target data set and the source data set are identified by dividing the target data set into a set of target data blocks. Among the target data blocks at least one duplicate block that is identical to a first portion of the source data set is identified. At least one modified block among the target data blocks for which complete content of the modified block is identical to no portion of the source data set is also identified. Differences between the modified block and the source data set are determined. A difference set is generated including representing content of the indication of the duplicate block by an instruction to copy the first portion of the source data set to a first destination in a target data set, and representing content of the modified block by an instruction to apply the difference between the source data set and the modified block to a second destination in the target data set.

In an implementation of a computer readable storage medium instructions to receive a source data set and a target data set are stored. Instructions identifying differences between the target data set and the source data set are also stored. These instructions include dividing the target data set into a set of target data blocks. Among the target data blocks at least one duplicate block in which an unbroken copy is fully duplicated within the source data set is identified. At least one modified block in the target data blocks in which an unbroken copy is not fully duplicated within the source data set is also identified. Differences between the modified block and the source data set are then determined.

These and other features and advantages will be apparent from reading the following detailed description and reviewing the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

In the drawings, like numerals represent like elements. In addition, the first digit in the reference numerals refers to the figure in which the referenced element first appears.

FIG. 1 is a block diagram of an operating environment for implementations of computer-implemented methods as herein described;

FIGS. 2A-2E are diagrams illustrating an implementation of the creation of a difference set;

FIG. 3 is a diagram illustrating an implementation of a system for communicating a difference set between two computing devices;

FIG. 4 is a diagram illustrating an implementation of a system for creating a difference set;

FIG. 5 is a diagram illustrating an alternative implementation of a system for creating a difference set;

FIGS. 6A-6C are diagrams illustrating an implementation of the creation of a difference set; and

FIG. 7 is a flow diagram illustrating an implementation of a process for creating a difference set.

### DETAILED DESCRIPTION OF IMPLEMENTATIONS

This detailed description describes implementations of a system for identifying differences and similarities between a source data set and a target data set, and for creating a corresponding difference set. Generally, to identify differences between the source data set and the target data set, the target data set is divided into blocks. Among the target bocks, a duplicate block that is included within the source is identified. Among the target blocks in which no duplicate has been identified, a longest subsequence matching process may be executed to identify duplicate data substrings found within the source. Once the differences are identified, a difference data set may be generated by including instructions to duplicate source data blocks into the target data set, instructions to copy duplicate data substrings into the target data set, and instructions to add into the target data set the remaining data.

### Illustrative Operating Environment

Implementations of identifying differences between source data set and a target data set, and the creation of a difference set may be supported by a number of electronic or computerized devices to generate the database query, either locally or over a network. Similarly, implementations for creating a target data set from a source data set and a difference set may also be supported by a number of electronic or computerized devices to generate the database query, either locally or over a network.

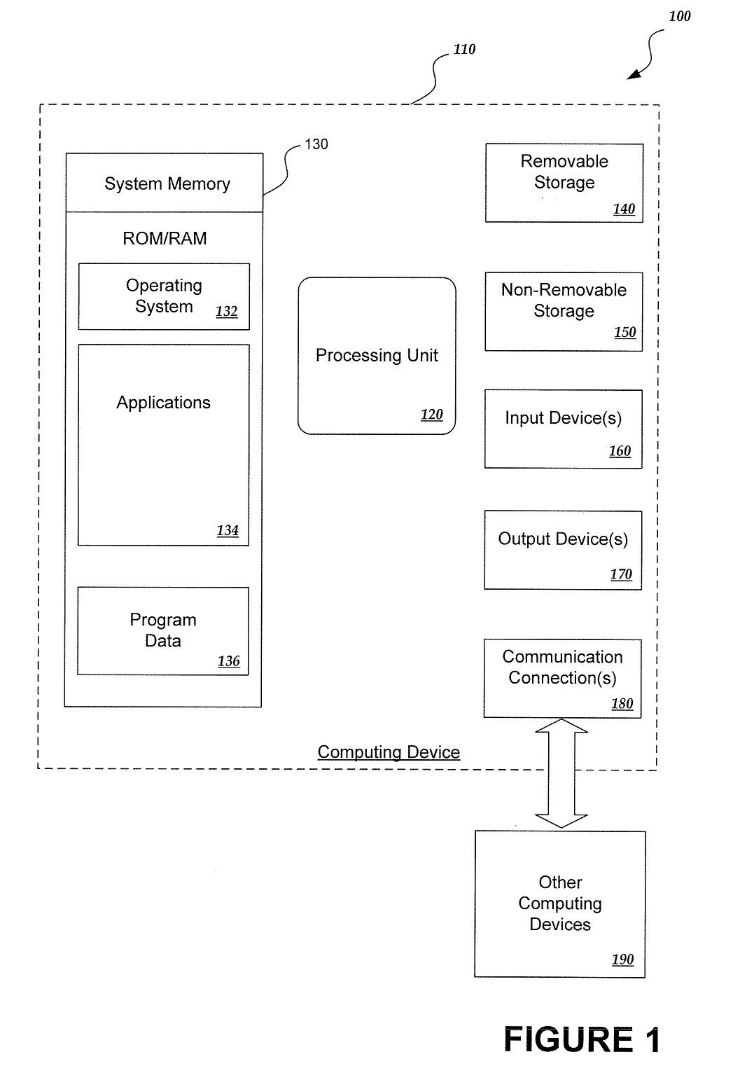

FIG. 1 is a block diagram of a representative operating environment 100. In a basic configuration, the computing device 110 may include a stationary computing device or a mobile computing device. The computing device 110 typically includes at least one processing unit 120 and system memory 130. Depending on the exact configuration and type of computing device, the system memory 130 may be volatile (such as RAM), non-volatile (such as ROM, flash memory, and the like) or some combination of the two. The system memory 130 typically includes an operating system 132, one or more applications 134, and may include program data 136.

The computing device 110 may also have additional features or functionality. For example, the computing device 110 may also include additional data storage devices (removable and/or non-removable). Implementations of the computing device 110 that are stationary computing devices may include, for example, magnetic disks, optical disks, or tape, while implementations of the computing device 110 that are mobile computing devices may include, for example, compact flash cards. Such additional storage is illustrated in FIG. 1 by removable storage 140 and non-removable storage 150. Computer storage media may include volatile and non-volatile, removable and non-removable media implemented in any method or technology for storage of information, such as computer readable instructions, data structures, program modules or other data. The system memory 130, the removable storage 140 and the non-removable storage 150 are all examples of computer storage media. Computer storage media includes, but is not limited to, RAM, ROM, EEPROM, flash memory or other memory technology or medium which can be used to store the desired information and which can be accessed by the computing device 110. Any such computer storage media may be part of the device 110. The computing device 110 may also have input device(s) 160. Implementations of the computing device 110 that are stationary computing devices may included, for example, a keyboard, mouse, pen, voice input device, touch input device, etc., while implementations of the computing device 110 that are mobile computing devices may included, for example, voice input device, touch input device, etc. Output device(s) 170 such as a display, speakers, etc. may also be included.

The computing device 110 also contains communication connection(s) 180 that allow the device to communicate with other computing devices 190, such as over a network or a wireless network. The communication connection(s) 180 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared, magnetic and other wireless media. The term computer readable media as used herein includes both storage media and communication media.

### Creation of Difference Set Using Page Copy Instructions

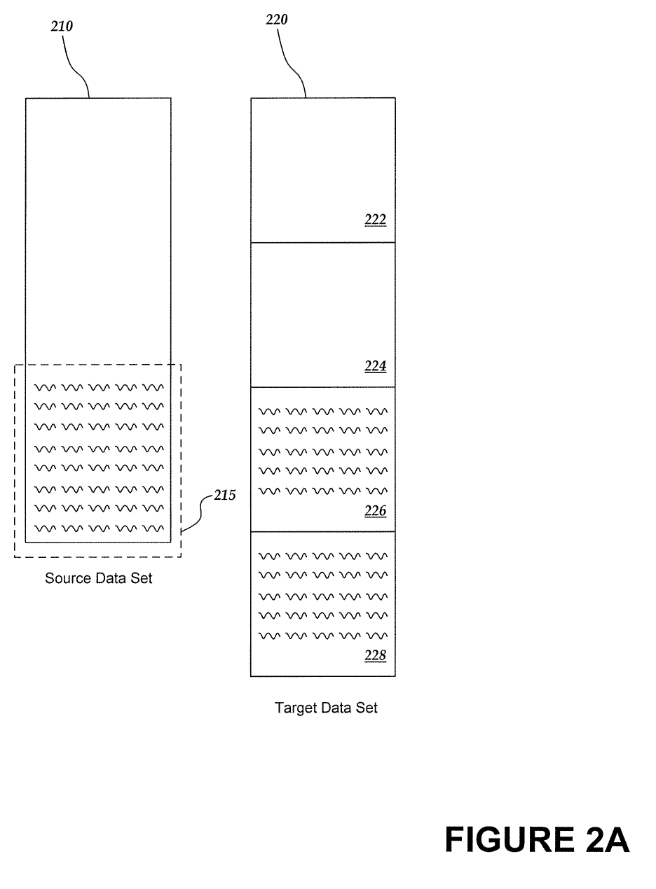

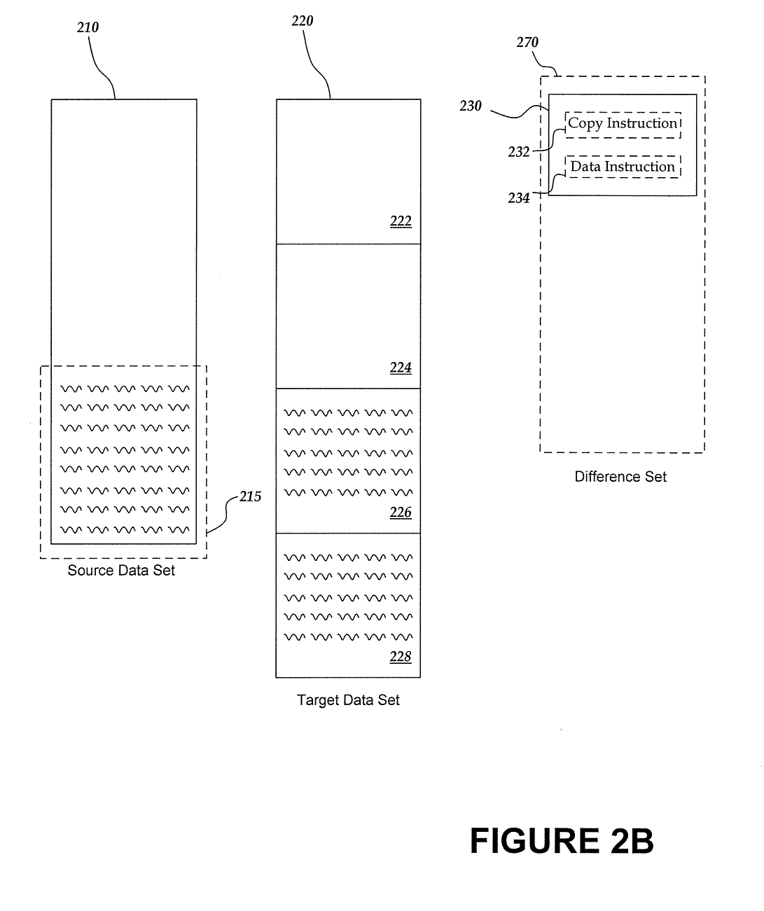

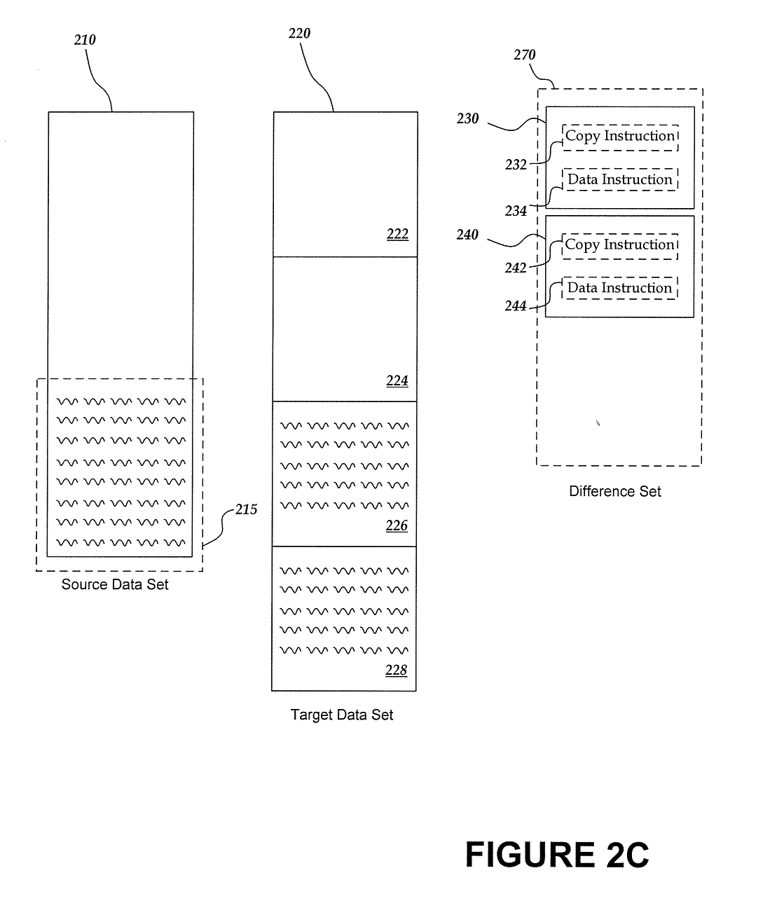

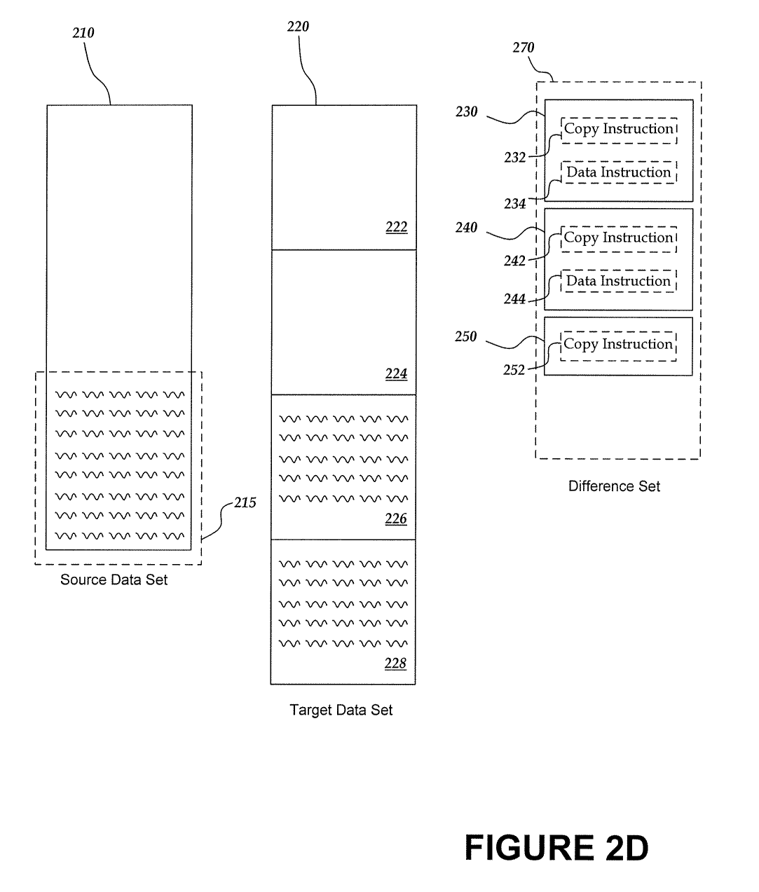

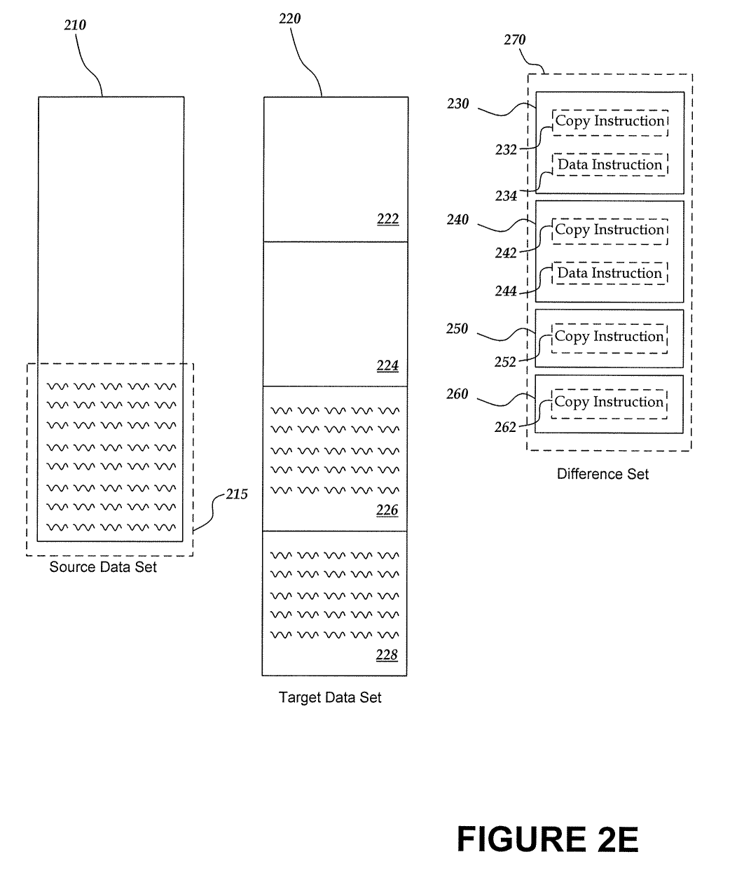

FIG. 2 shows an implementation of a source data set 210 and a target data set 220. The source data set 210 includes a large amount of repeated data. For example, a portion 215 of the source data may include many repetitions of the string “0111.” The target data set 220 is divided into four blocks: target block 222, target block 224, target block 226 and target block 228. An unbroken copy of the complete target block 222 is not included within the source data set 210. The target block 222 does contain some subsections of information that are included in the source data set 210 and some subsections of information that are not included within the source data set 210. The target block 224 also contains some subsections of information that are included in the source data set 210 and some subsections of information that are not included in the source data set 210. The target blocks 226 and 228 contain many repetitions of the string “0111,” and match information included within the portion 215.

Where large portions of repeated data, such as many repetitions of the string “0111,” are present in both sets of data, executing a longest subsequence matching process may be computationally intensive. In general, when large portions of repeated data are present in the target data, matching portions of the repeated data are often present in the source data. Because the portions of repeated data are often very large, rather than executing the costly longest subsequence matching process, it is advantageous to first check for matching blocks. By identifying whether a block of target data is identically found in the source data, much of the repeated data may be located without the need to execute a longest subsequence matching process. This may dramatically reduce the amount of computation required when handling repeated data.

FIG. 2B shows an implementation of a first portion 230 of a difference set 270 including instructions for creating a copy of the target block 222 from the source data set 210. The creation of the first portion 230 of the difference set begins with the execution of a page comparison of the first target block 222 to the source data set 210. In this case, such a comparison would reveal that an unbroken copy of the complete target block 222 is not included within the source data set 210. The target data block 222 is therefore a non-matching target block and a longest subsequence matching process is executed. In response to this process the first portion 230 of the difference set 270 is created. The first portion 230 of the difference set 270 includes copy instructions 232 to copy a sub-portion of the source data set 210 to a copy of the target data set 220 where data is common to both the source data set 210 and the target block 222. The partial difference set 230 also includes data instructions 244 to add data not present in the source data set 210 to the copy of the target data set 220. Thus, the first portion 230 may provide instructions for the creation of a copy of the target block 222 from the source data set 210.

FIG. 2C shows an implementation of a second portion 240 of the difference set 270 including instructions for creating a copy of the target block 224 from the source data set 210. Similar to the creation of the first portion 230 of the difference set 270, the creation of the second portion 240 of the difference set 270 begins with the execution of a page comparison of the second target block 224 to the source data set 210. In this case, such a comparison would also reveal that an unbroken copy of the complete target block 224 is not included within the source data set 210. The target block 224 is therefore a non-matching target block and a longest subsequence matching process is executed. In response to this process the second portion 240 of the difference set is created. The second portion 240 of the difference set 270 includes a copy instruction 242 to copy a sub-portion of the source data set 210 to the copy of the target data set 220 where data is common to both the source set 210 and the target block 224. The partial difference set 230 may also include data instructions 244 to add data not present in the source data set 210 to the copy of the target data set 220. Thus, the second portion 240 may provide instructions for the creation of a copy of the target block 224 from the source data set 210.

FIG. 2D shows an implementation of a third portion 250 of the difference set 270 including instructions for creating a copy of the target block 226 from the source data set 210. The creation of the third portion 250 of the difference set 270 begins with the execution of a page comparison of the third target block 226 to the source data set 210. In this case, the comparison identifies that an unbroken copy of the complete target block 226 is included within the portion 215 of the source data set 210. In response to finding a match, a single instruction 252 is created in the fourth portion 250 of the difference set 270 to copy the matching block of data from the portion 215 of the source data set 210 to the copy of the target data set 220. Because the entire target block 226 may be created by a single copy instruction, no additional data instruction is needed.

FIG. 2E shows an implementation of a final portion 260 of the difference set 270 including instructions for creating a copy of the target block 228 from the source data set 210. The creation of the final portion 260 of the difference set 270 begins with the execution of a page comparison of the final target block 228 to the source data set 210. In this case, the comparison identifies that an unbroken copy of the target block 226 is included within the portion 215 of the source data set 210. As a result of this comparison, a single instruction 262 is created in the difference set 270 to copy the matching block of data from the portion 215 of the source data set 210 to the copy of the target data set 220. Because the entire target block 228 may be created by a single copy instruction, no additional data instruction is needed. Thus, together the portions 230-660 form the difference set 270 to provide instructions for the creation of a copy of the target data set 220 from the source data set 210.

Although the above implementation was described with reference to working with raw data, a similar process may be applied when working with hashes. The portions 230-260 may be created based on hash comparisons or raw data comparisons. For example, in a hash based implementation the creation of the final portion 260 of the difference set begins with the execution of a page comparison of a hash of the target block 228, to a hash of the source data set 210. In this case, the comparison identifies that an unbroken copy of the complete hash of the target block 226 is included within a portion of the source hash that is associated with the portion 215. That is, because the hash of the target block 228 matches the portion of the source data hash associated with the portion 215, the target block 228 contains data that matches the portion 215. Thus, as a result of the hash comparisons, an instruction 262 is created in the final portion 260 of the difference set to copy the matching block of data from the portion 215 of the source data set 210 to the copy of the target data set 220. In this manner, a difference set may be created by hash comparisons as well as raw data comparisons.

### Creation and Transmission of a Difference Set

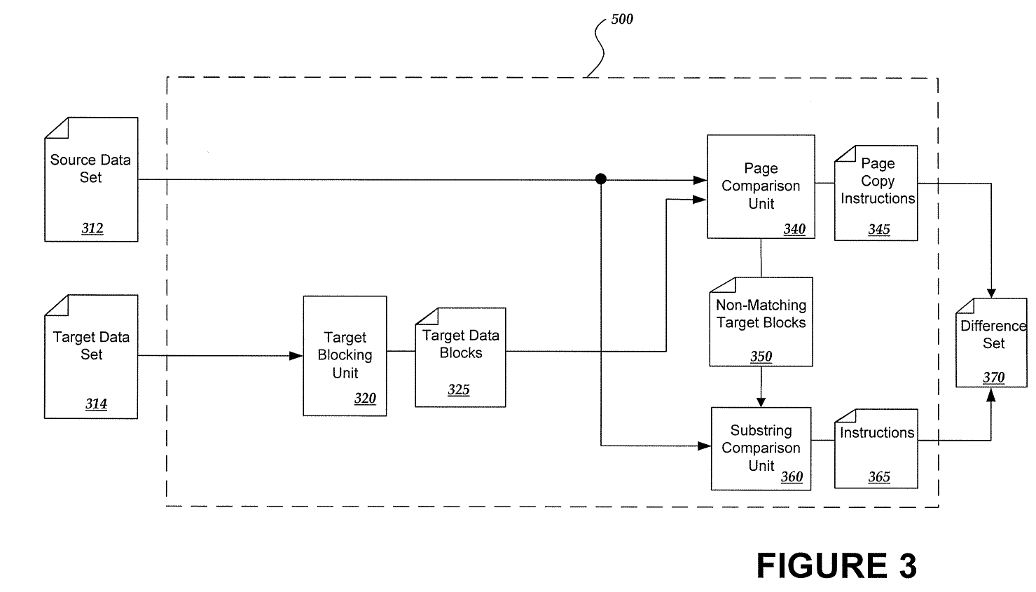

FIG. 3 shows an implementation of a system for transmitting a difference set of data 335 between a transmitting system 310 and a receiving system 320. The difference set 335 is a set of data that reflects differences between a source data set 312 and a target data set 314. The difference set 335 is created by a differencing system 315 on the transmitting system 310. The differencing system 315 receives as input the source data set 312 and the target data set 314. The differencing system 315 identifies the differences and similarities between the source data set 312 and the target data set 314. Where similarities are found, the differencing system inserts into the difference set 335 instructions to copy the similar information from the source data set to the target data set copy 324. Where differences are found and data in the target set 314 is not found in the source data set 312, the differencing system 315 inserts into the difference set 335 instructions to insert the needed data into the target data set copy 324. Thus, based on the identified similarities and differences between the source data set 312 and the target data set 314, the differencing system 315 creates a difference set 335 that includes instructions for creating the target data set copy 324 from the source data set 312.

Once the difference set 335 is created at the transmitting system 310, it may be transmitted to the receiving system 320. Although the transmitting system 310 receives a copy both of the source data set 312 and the target data set 314, the receiving system 320 receives a copy of the source data set 312 but not the target data set 314. For example, when a hardware system, such as a cellular phone, is manufactured, a transmitting system may be located at the manufacturing facility and may upload an operating system to the cellular phone. After manufacture, the cellular phone is sold to a user and is no longer located at the manufacturing facility. When the manufacturer creates an updated operating system, the transmitting system has direct access to it, but the cellular phone does not. Thus, the transmitting system has direct access to the old operating system and the new operating system, while the cellular phone has direct access only to the old operating system. To update the cellular phone, a copy of the new operating system is needed on the cellular phone. In many cases, only minor modifications to the operating system may be present between the old and the new operating system, and therefore, a difference set that is created may be small. Thus, the cost of updating the operating system may be reduced by transmitting only a difference set, rather than a full copy of the new operating system.

To transmit the difference data set 335 from the transmitting system 310 to the receiving system 320, the difference data set 335 is first transmitted into a network 350 by an antenna 340 that is coupled to the transmitting system 310. The difference set 335 is then received from the network 350 at an antenna 360. From the antenna 360, the difference set 335 is then transferred to the receiving system 320. After receiving the difference set 335, the receiving system 320 has as input both the difference set 335 and the source data set 312. A reconstruction system 325 then executes the instruction of the difference set 335 to create the target data set copy 324 from the source data set 312. Thus, a local copy of the target data set 314 is obtained at the receiving system 320 without the need to directly transmit the target data set 314. Although the system 300 is described with reference to wireless transmission, the same process applies equally to any form of transmission. For example, savings may also be realized when updates are transferred over a wired network, or even when transferred on physical storage media, such as a compact disc or any other storage media known to those of ordinary skill in the art. By transferring the difference set, bandwidth and/or the number of compact disks, needed may be reduced.

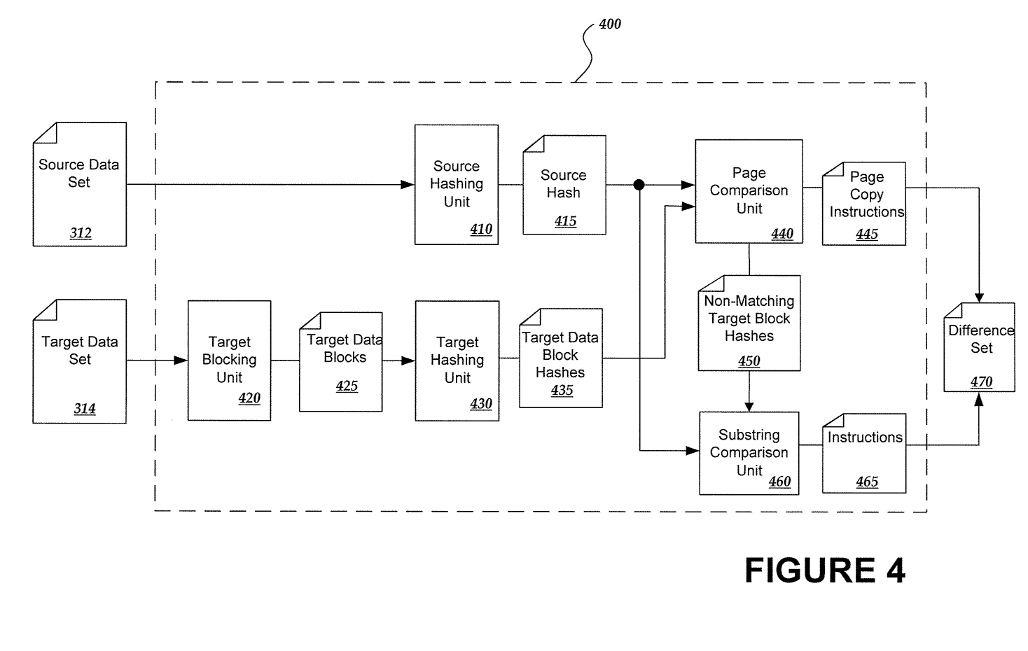

FIG. 4 shows an implementation of a differencing system 400 to create a difference set 470. The differencing system 400 receives a copy of the source data set 312. The source data set 312 is transmitted to a source hashing unit 410. The source hashing unit 410 creates a source hash 415 of the source data set 312. The source hashing unit 415 may use any standard hashing process, such as an exclusive or (XOR) function. The source hash 415 is transmitted to a page comparison unit 440 and a substring comparison unit 460.

The differencing system 400 also receives the target data set 314. The target data set 314 is passed to a target blocking unit 420. The target blocking unit 420 divides the target data set 314 into a set of target data blocks 425. The target data set 314 may be divided into target data blocks of any size. In some implementations the target blocking unit 420 may divide the target data set 314 into blocks having a size similar to that of pages associated with the target data set 314. After the target data set 314 has been divided into target data blocks 425, the target data blocks 425 are transmitted to a target hashing unit 430. The target hashing unit 430 hashes each of the target data blocks 425 to create a set of target data block hashes 435. The target hashing unit 430 may use any standard hashing process, such as an XOR function. In some implementations, the target hashing unit 430 may use the same hashing process as the source hashing unit 410 to facilitate comparisons between the hashes. Once the target data blocks 425 have been hashed by the target hashing unit 430, the target data block hashes 435 are transmitted to the page comparison unit 440.

The page comparison unit 440 identifies the individual target block hashes 425 that do not match any portion of the source hash 415. This may be determined by searching the source hash 415 for an unbroken copy of the string of hash data of each of the individual target block hashes 425. If an unbroken copy of a full target block hash is included within the source hash 415, a match is found. The page comparison unit then creates a set of page copy instructions 445 that correspond to each target hash block that matches a portion of the source hash 415. The page copy instructions 445 are instructions to copy a portion of the source data set 312 associated with the portion of the source data hash 415 that matched the target data block hash. The copy instructions 445 are added into a difference data set 470. If an unbroken copy of the full target block hash is not included within the source hash 415, no match is found. The page comparison unit 440 transmits a set of non-matching target block hashes 450 to a substring comparison unit 460.

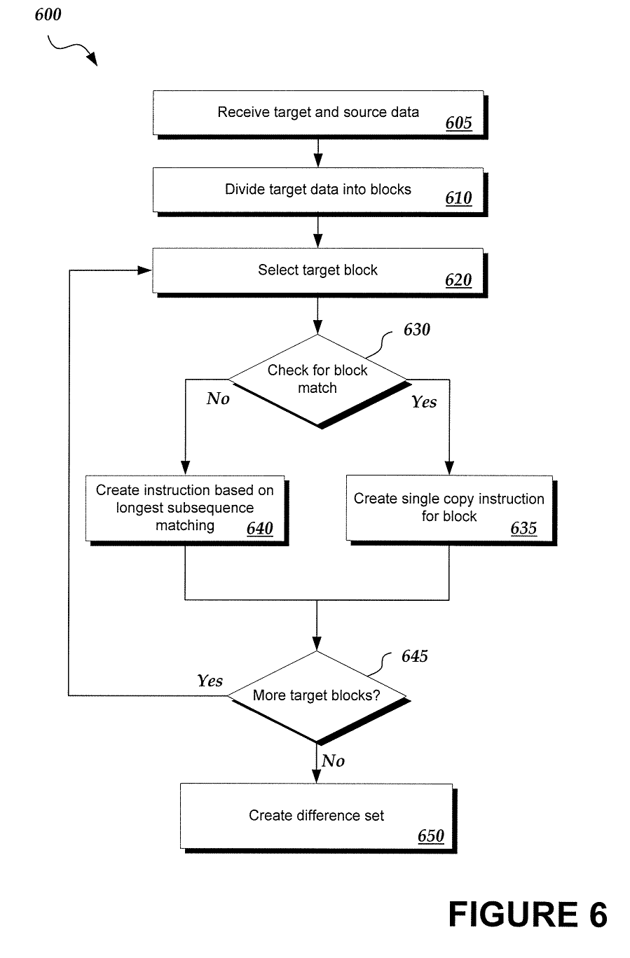

The substring comparison unit 460 receives the non-matching target hashes 450 and the source hash 415. The substring comparison unit 460 then identifies the sub-portions of each non-matching target block hash 450 that are included within the source hash 415, and the sub-portions of each non-matching target block hash 450 that are not included within the source hash 415, as described in more detail below with reference to FIG. 6A-C. The string comparison unit creates a set of instructions 465 describing the identified differences and similarities. The set of instructions 465 are then added into the difference data set 470.

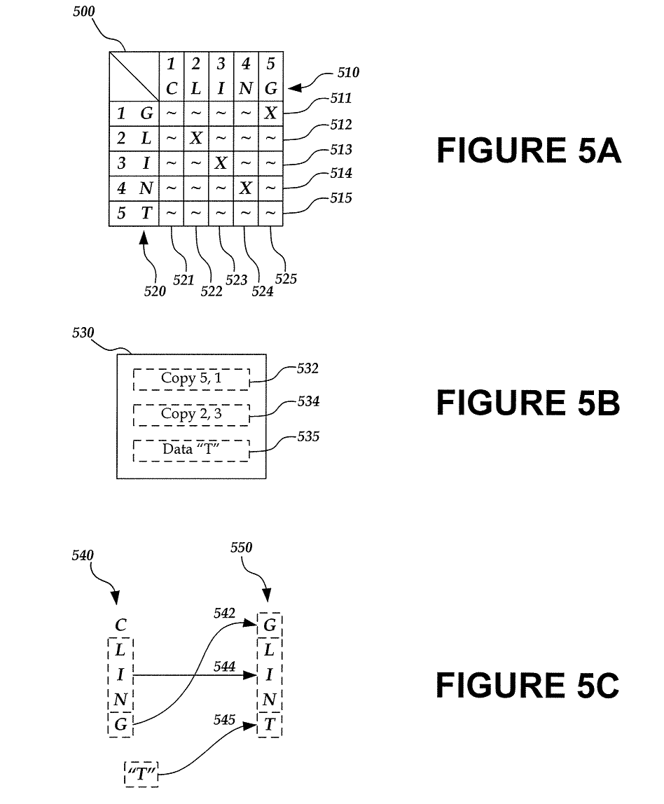

FIG. 5 shows an alternative implementation of a differencing system 500 to create a difference set 570. The differencing system 500 works similarly to the differencing system 400, but no hashes are used. The differencing system 500 includes a target blocking unit 520 that divides the target data set 314 into set of target data blocks 525. A page comparison unit 540 receives as input the target data blocks 525 and the source data set 312. The page comparison unit 540 compares the target data blocks 525 directly to the source data set 312, rather than working with hashes. To conduct this comparison, the page comparison unit 540 identifies the individual target data blocks 550 in which an unbroken copy of the full target data block is not included within the source data set 312. The page comparison unit 540 transmits the non-matching target data blocks 550 to a substring comparison unit 560. The target data blocks in which an unbroken copy of the full target data block is included within the source data set 312 are used by the page comparison unit 540 to create a set of page copy instructions 545. The page copy instructions 545 are added into the difference data set 470.

The resulting page copy instructions 545 may be similar to the page copy instructions 445 of the differencing system 400. In rare instances, the target data block hashes may match the source hash, while the underlying target data block does not match the source data. Other than in these rare errors cases, the page copy instructions 545 would be identical to the page copy instructions 445. Thus, the generation of page copy instructions may not depend on whether hashes or raw data are used for the page comparison.

Similarly, the substring comparison unit 560 may function similarly to the substring comparison unit 460. That is, the substring comparison unit 560 may process raw data similar to the manner in which the substring comparison unit 460 processes hashed data. The substring comparison unit 560 of the differencing system 500 receives as input the non-matching target data blocks 550 and the source data set 312. The substring comparison unit 560 then identifies the sub-portions of each non-matching target block 550 that are included within the source data set 312, and the sub-portions of each non-matching target block 550 that are not included within the source data set 312. The substring comparison unit 560 then creates a set of instructions 565 describing the identified differences and similarities. The instructions 565 are then included in the set of difference instructions 570.

The resulting instructions 565 are similar to the instructions 465 of the differencing system 400. That is, except in the rare error case where sub-portions of the target data block hashes match the source hash but the underlying target data does not match the source data, the page copy instructions 545 would be identical to the page copy instructions 445. Thus, the instructions 545 may not depend on the method of string comparison made. Therefore, the final difference data set 570 may be identical to the difference data set 470.

FIGS. 6A-6C shows an implementation of a process for creating a difference set. An implementation of this process may be executed by the substring comparison unit 460 of FIG. 4 or the substring comparison unit 560 of FIG. 5. To create a difference set that includes instructions to build a target data set copy from a source data set, two instructions types are used: copy instructions and data instructions. A copy instruction is a command to copy a portion of the source data to the target data set copy. Copy instructions may be used where there is a portion of information common between both data sets. A data instruction is a command to insert a portion of data, which was not contained in the source data set, into the target data set copy. Data instructions may be used where the target data set contains data not found within the source data set.

Many possible combinations of copy instructions and/or data instructions may be used in the difference set to describe the building of a target data set copy. For example, one possible difference set includes a single data instruction. A complete target data set copy may be created by a single data instruction that includes a command to insert a large string of data associated with the entire target data set. This single data instruction would, however, be no smaller than the original target data set itself. Another possible difference set includes many single-bit copy and/or data instructions. A complete target data set copy may also be created by many single-bit instructions corresponding to each bit of the target data set. Again, this difference set would be no smaller than the target data set itself.

On the other hand, a very small difference set may be created when the source data set is identical to the target data set. In this situation, the difference set may include a single copy instruction. Unlike the single data instruction that includes the full description of the target data set, a single copy instruction may simply include reference to the location from where the material should be copied and the length of the string that should be copied. This difference set may therefore be small and thus efficiently transmitted from one computer to another, as described above in relation to FIG. 3.

In general, however, a target data set may contain some data that is common to the source data and some data that is unique to the target data set. In this case, to create a difference data set that contains the least amount of information possible, the longest data strings that both sets have in common are located. This may be accomplished by a longest subsequence matching process. For example, the target data set may include the string “GLINT” and the source data set may include the string “CLING.” To identify the longest substrings of characters that the strings “CLING” and “GLINT” have in common, and to identify the data that is unique to “GLINT,” a longest subsequence matching process may be executed. One implementation of a longest subsequence matching process begins with inserting the source data and the target data into a table.

FIG. 6A shows a table 600 in which a source data set 610 and a target data set 620 have been inserted. The source data set 610 includes the string “CLING” and is displayed above columns 621-625. Each column is associated with a character of the source data set 610. For example, column 621 is associated with the “C” of “CLING” in the source data set 610. The target data set 620 includes the string “GLINT” and is displayed to the left of rows 611-615. Each row is associated with a character of the target data set 620. For example, row 611 is associated with the “G” of “GLINT” in the target data set 620.

To locate the longest subsequences that the source data set 610 and the target data set 620 have in common, an “X” is placed in each cell where an individual character is shared. For example, the column 621 contains five cells that are each associated with the “C” of “CLING.” Each of these cells also corresponds to a particular character associated with the row within which they are included. For example, the first cell of column 621 is also the first cell of row 611. Thus, the first cell of column 621 is associated with both the “C” of “CLING” and the “G” of “GLINT,” and thus a match is not present. Similarly, the second cell of the column 621 is also the first cell of the row 612. Thus, the second cell of the column 621 is associated with both the “C” of “CLING” and the “L” of “GLINT,” and thus a match is not present. Each other cell of the column 621 is associated with a character that does not match “C,” and thus no “X” marks are present in column 621.

Similarly, the column 622 is associated with the “L” of “CLING.” Thus, the column 622 contains five cells that are each associated with “L.” In this case, row 612 is also associated with an “L.” Thus, an “X” is placed in the cell associated with column 622 and row 612 to indicate a common character. This process is then repeated for each column, resulting in an “X” placed at each location where the character associated with a column is common to a character associated with a row intersecting that column.

After the “X” marks are placed, the consecutive “X” marks are grouped together as a matching subsequence. For example, an “X” mark associated with the “G” of “CLING” is found at the column 625 and the row 611. There are no “X” marks present either directly before or directly after it. Because there are no consecutive matching characters, it is grouped into a subsequence of only one character. On the other hand, the “X” mark associated with the “L” of “CLING” is consecutively next to two additional “X” marks: the “X” marks of the “I” and the “N” of “CLING.” These three “X” marks are located in consecutive columns of the source data set 610. Further, these three “X” marks are also located in consecutive rows of the target data set 620. Thus, because these three “X” marks are consecutive in both the source data set 610 and the target data set 620, they are identified as a matching subsequence and the characters associated with the “X” marks are grouped together. This process is repeated to identify all of the longest matching subsequences.

Although the implementation of a longest matching subsequence process described above searches each row for a character that matches a selected column, in other implementations the process may be reversed. For example, a row may be selected and each column may be searched for a match. This process would result in the same set of “X” marks and thus would identify the same set of longest matching subsequences.

FIG. 6B shows an implementation of a difference set 630 that includes instructions created to describe the modifications that may be applied to the source data set 610 “CLING” to create a copy of the target data 620 “GLINT” based on the longest matching subsequences identified in table 600. The difference set 630 begins with an instruction 632 associated with the subsequence containing the first character of the target data set 620, “G.” As discussed above with reference to FIG. 6A, the longest subsequence containing “G” was the single-character subsequence “G.” To replicate the “G” of the source data set 312 in a copy of the target data set 314, a copy instruction 632 is inserted into the difference set 630. The copy instruction 632 defines the column from where the data is to be copied, and the length of the string that is to be copied. In this case, only one character, “G,” is to be copied from the fifth column. Thus, the copy instruction 632 reads “Copy 6, 1.” The difference set 630 continues with an instruction 634 associated with the subsequence containing the second character of the target data, “L.” As discussed above with reference to FIG. 6A, “L” is incorporated as part of a subsequence of three characters, “LIN,” that begins at the second column of the source data set 610. Thus, the instruction 634 is a copy instruction that reads “Copy 3, 4.”

In combination, the first two instructions 632 and 634 define the first four characters of the target data set 620. The final character of the target data set 620, “T,” is not included within the source data set 610. Thus, a copy instruction may not be used. In order to generate the final character of the target data set 620, a data instruction 636 is included within the difference set 630. The data that is to be inserted is included within the data instruction. The data instruction 636 is a command to insert a piece of data in the target data set copy 650. Thus, this data instruction 636 reads “Data ‘T’” to instruct that a “T” be inserted into the target data set copy 650.

FIG. 6C shows a graphical representation 640 of the execution of the instructions of the difference set 630 of FIG. 6B. A first transformation 642 represents the execution of the first copy instruction 632 of FIG. 6B. There, a string of one character that begins at the fifth character of the source data set 610 is copied to the beginning of a target data set copy 650. That is, the “G” of “CLING” is copied from the source data set 610 to the target data set copy 650 to form the “G” of “GLINT.” Because this was the first transformation executed, the information was copied to the beginning of the target data set copy 650. A second transformation 644 represents the execution of the second copy instruction 634 of FIG. 6B. There, a string of three characters that begins at the second character of the source data set 610 is copied to the next position of the target data set copy 650. That is, the “LIN” of “CLING” is copied from the source data 610 to the target data set copy 650 to form the “LIN” of “GLINT.”Because one character is already placed in target data set copy 650, “G,” “LIN” is copied to a location beginning at the second character of the target data set copy 650. A third transformation 646 represents the execution of the data instruction 636 of FIG. 6B. There, a string of one character, “T,” is inserted into the target data set copy 650. Because four characters are already included within the target data set copy 650, the “T” is inserted into a location beginning at the fifth character of the target data set copy 650. Thus, through the execution of the three transformations 642, 644, and 646, the target data set copy 650 is created from the source data 610.

Although FIGS. 6A-6C describe a longest subsequence matching process that is executed on the raw source data 610 and the raw target data 620 to create the difference set 630, any form of data may be used. For example, the source data 610 and the target data 620 may first be hashed and a hash table created. The similarities and differences between the source data 610 and the target data 620 may be determine with reference to the similarities and differences between hashes. Similarly, any process may be used to identify the similarities and differences between the source data 610 and the target data 620 in order to create the difference set 630. Further, any format of instructions may be used. For example, rather than building the copy of the target data set 650 from beginning to end, the individual instruction may define the position within the copy of the target data set 650 the corresponding data is to be placed.

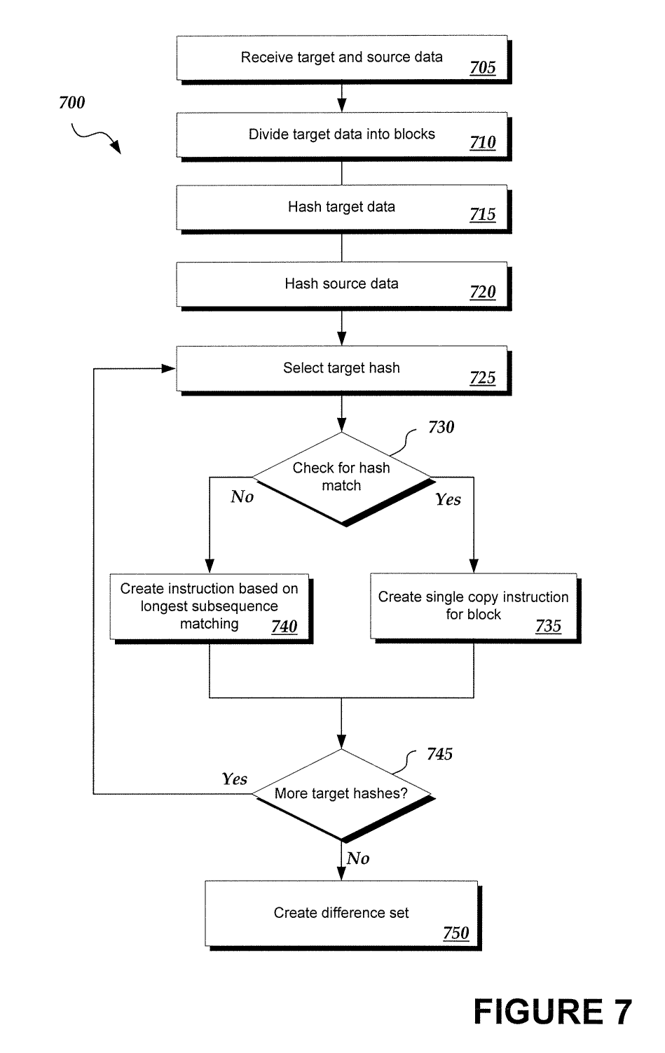

FIG. 7 shows a flow diagram representing an implementation of a hash-based process 700 for creating a difference set. At 705, the diagram of the process 700 begins when the target data and source data are received. At 710, the target data is divided into blocks. The size of the blocks may, for example, be equal to a page size associated with the target data. At 715, a hash of each of the target data blocks is created. Any standard hashing process, such as an XOR function, may be used to create the target data block hashes. At 720, a hash of the source data may be created. Any standard hashing process, such as an XOR function, may be used to create the source hash. To facilitate comparisons between the hashes, in some implementations, the hashing process used to create the hash of the source data may be the same process used to create each of the target data hashes.

At 725, a first target hash is selected from among the target hashes. At 730, a determination is made as to whether the selected target hash matches any portion of the source data hash. This may be determined by searching the source hash for an unbroken copy of the selected target hash. If an unbroken copy of the selected target hash is located within the source hash, a match is found. If an unbroken copy of the selected target hash is not located within the source hash, no match is found. If a match is found, the diagram of the process 700 continues to 735. At 735, a copy instruction is created to copy a portion of the source data associated with the portion of the source data hash that matches the selected target data hash. If a match is not found, the diagram of the process 700 continues to 740.

At 740, a longest subsequence matching process is executed. This process identifies both the sub-portions of each non-matching target hash that are included within a portion of the source hash, and the sub-portions of each non-matching target hash that are not included within the source hash. Based on the results of the longest subsequence matching process, a set of instructions is created that describe the building of a copy of the sub-portions of the target data associated with the non-matching target hash from the source data set. As described in more detail above with reference to FIGS. 5A-5E, the instructions may include both data and copy instructions.

At 745, a determination is made whether another target data block needs to be evaluated. When not all of the target data blocks have been evaluated, the diagram of the process 700 returns to 725 and the next target block hash is selected. When all of the target data block hashes have been evaluated, and no further target data block hashes remain, the diagram of the process 700 continues to 750. At 750, all of the instructions are combined to create the difference set and the diagram of the process 700 ends.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method comprising:
receiving a source data set and a target data set; and
identifying differences between the target data set and the source data set, including:
dividing the target data set into a set of target data blocks;
identifying among the target data blocks at least one duplicate block that is identical to a first portion of the source data set;
identifying at least one modified block among the target data blocks for which complete, unbroken content of the modified block is not included within the source data set; and
determining differences between the modified block and the source data set.

2. The computer-implemented method of claim 1, wherein the identifying among the target data blocks at least one duplicate block further includes:
generating target data block hashes of each of the target data blocks;
generating a source hash of the source data set; and
identifying among the target data block hashes at least one duplicate hash that is identical to a first portion the source data hash.

3. The computer-implemented method of claim 1, wherein a size associated with the target data blocks is equal to a page size associated with the target data set.

4. The computer-implemented method of claim 1, wherein the determining differences between the modified block and the source data set further includes executing a longest subsequence matching process.

5. The computer-implemented method of claim 1, further comprising generating a difference set including representing:
content of the duplicate block by an instruction to copy the first portion of the source data set to a first destination in a target data set; and
content of the modified block by an instruction to apply the differences between the source data set and the modified block to a second destination in the target data set.

6. The computer-implemented method of claim 1, wherein the identifying differences between the target data set and the source data set further includes, for the at least one modified block, determining a similarity between the source data set and a portion of the modified block.

7. The computer-implemented method of claim 6, further comprising generating a difference set including representing:
content of the duplicate block by an instruction to copy the first portion of the source data set to a first destination in a target data set; and
content of the modified block by an instruction to apply the difference between the source data set and the modified block to a second destination in the target data set.

8. The computer-implemented method of claim 7, wherein the generating a difference set further includes representing content of the at least one modified block by an instruction to copy the similarities between the source data set and the modified block to a third destination in the target data set.

9. The computer-implemented method of claim 8, further comprising transmitting the difference set over a wireless network.

10. A computer-implemented method of generating a difference set comprising:
receiving a target data set;
dividing the target data set into a plurality of target data blocks;
receiving a source data set;
identifying among the target data blocks, duplicate blocks in which an unbroken copy of each duplicate block is located within the source data set;
inserting within the difference set an instruction to copy a portion of the source data set that includes the unbroken copy of the duplicate block;
identifying among the target data blocks, modified blocks in which an unbroken copy of each modified block is not located within the source data set;
determining differences and similarities between the modified blocks and the source data set; and
inserting within the difference set instructions describing the similarities and differences between the modified blocks and the source data set.

11. The computer-implemented method of claim 10, wherein the identifying among the target data blocks duplicate blocks further includes:
generating target data block hashes of each of the target data blocks;
generating a source hash of the source data set; and
identifying among the target data blocks hashes duplicate block hashes in which an unbroken copy of each duplicate block hash is located within the source data hash.

12. The computer-implemented method of claim 10, wherein a size associated with the target data blocks is equal to a page size associated with the target data set.

13. The computer-implemented method of claim 10, wherein the determining differences and similarities between the modified blocks and the source data set further includes, executing a longest subsequence matching process.

14. The computer-implemented method of claim 10, wherein the determining differences and similarities between the modified blocks and the source data set further includes for the at least one modified block, determining a similarity between a sub-portion of content of the modified block and the source data.

15. The computer-implemented method of claim 14, further including inserting into the difference set an instruction that represents content of the at least one modified block by an instruction to copy the similarity between the at least one modified block and the source.

16. The computer-implemented method of claim 10, further comprising transmitting the difference set over a network.

17. A computer readable storage medium storing instructions to:
receive a source data set and a target data set; and
identify differences between the target data set and the source data set, including:
dividing the target data set into a set of target data blocks;
identifying among the target data blocks at least one duplicate block in which an unbroken copy is fully duplicated within the source data set;
identifying at least one modified block in the target data blocks in which an unbroken copy is not fully duplicated within the source data set; and
determining differences between the modified block and the source data set.

18. The computer readable storage medium of claim 17, wherein the determining the differences between the modified block and the source data set further includes:
generating target data block hashes of each of the target data blocks;
generating a source hash of the source data set; and
identifying among the target data block hashes at least one duplicate hash that is identical to a first portion of the source data hash.

19. The computer readable storage medium of claim 18, wherein the determining differences between the modified block and the source data set further includes:
identifying among the target data block hashes at least one modified hash in which the complete content of the modified hash is not included within the source data hash as a single string of data;
identifying a similarity between a second portion of the source data hash and a first portion of the hash block; and
identifying a difference between the source data hash and a second portion of the modified hash.

20. The computer-implemented method of claim 19, further comprising an instruction to generate a difference set including representing:
an instruction to copy a first portion of the source data that is associated with the first portion of the source data hash to a copy of the target set;
an instruction to copy a second portion of the source data that is associated with the second portion of the source data hash to copy of the target set; and
an instruction, which includes a portion of the target data set associated with the difference, to insert the portion of the target data set associated with the difference in the copy of the target data set.
